(19) United States
(12) Patent Application Publication
(10) Pub. No.: US 2014/0370151 A1
(43) Pub. Date: Dec. 18, 2014

(54) Method for Producing Sweet Bran and the Resultant Product

(71) Applicant: Bob J. Dull, Akron, OH (US)

(72) Inventor: Bob J. Dull, Akron, OH (US)

(21) Appl. No.: 14/302,001

(22) Filed: Jun. 11, 2014

Related U.S. Application Data
(60) Provisional application No. 61/834,142, filed on Jun. 12, 2013.

(51) Int. Cl. A23L 1/10; A23L 1/105

(52) U.S. Cl. CPC A23L 1/1016; A23L 1/1025; A23L 1/1055; A23V 2002/00
USPC 426/31; 426/626; 426/627

(57) ABSTRACT

Provided herein is a method for treating untreated rice bran to produce a treated rice bran. The method comprises inactivating lipase in the untreated rice bran, saponifying the fatty acids in the untreated rice bran to fatty acid salts, and contacting the untreated rice bran with a source of bisulfite anions so that an aldehyde or ketone in the untreated rice bran forms an organosulfite. The method produces the treated rice bran, wherein the amount and characterization of protein and fiber between the treated rice bran and the untreated rice bran remain unchanged. A treated rice bran composition is also provided, which comprises fatty acid salts, inactivated lipase, organosulfites, between about 14% and about 16% by weight protein, and between about 8% and about 10% by weight fiber.

### CROSS-REFERENCE

This application claims the benefit under 35 U.S.C. §119(e) of U.S. Provisional Application Ser. No. 61/834,142, filed Jun. 12, 2013, and entitled “A Method for Producing Sweet Bran and the Resultant Product,” which is incorporated by reference in its entirety.

### FIELD

The present disclosure relates to a method for producing bran from a cereal grain. In particular, the present disclosure relates to sweetening rancid bran by saponifying fatty acids and treating malodorous compounds with sulfite.

### BACKGROUND

Bran is rich in dietary fiber, essential fatty acids, and other nutrients. Bran in its natural form, however, cannot be used because it quickly goes rancid, which makes it unusable as a food or feed ingredient. Because the fat in the bran can go rancid very quickly, the fat is usually removed from the bran at a small-capacity extractor geographically close to where the bran was harvested. In addition, fat free bran still has lipase activity and that can impact formulations containing added fats. Removing these fats has the negative consequence of diminishing the nutritional value of the bran and decreasing desirable lubricity.

Other approaches to avoid rancidity have been attempted to improve the shelf life of bran. Quickly heating the bran can deactivate naturally occurring lipases, but the heat may also degrade the bran's nutritional value, thus denaturing proteins and destroying other sensitive nutrients. Proteases may be used instead of heat to destroy active lipases and lipoxygenases, with enzymatic activity eliminated by adding an acid having a pKa near the isoelectric point of the enzyme. Alternatively, the lipase substrate may be removed from the bran using, for example, antibodies or a means to remove co-factors important for enzyme activity. Disadvantageously, each of these approaches increases production costs and may make handling the bran more difficult.

What is desired is a method for treating rancid bran so that it is again edible and palatable as a food or feed ingredient. What is also desired is a method for stabilizing bran from becoming rancid, either through lipase action or autooxidation. Such a system would not denature the bran proteins or reduce the bran's nutritional quality. Additionally, such a method would convert naturally available free fatty acids into stable, odorless salts that do not react to lipoxygenase or other enzymes, and remove any malodorous autooxidation products, such as ketones and aldehydes.

Additional embodiments and features are set forth in part in the description that follows, and in part will become apparent to those skilled in the art upon examination of the specification, or may be learned by the practice of the embodiments discussed herein. A further understanding of the nature and advantages of certain embodiments may be realized by reference to the remaining portions of the specification and the drawings, which forms a part of this disclosure.

### SUMMARY

The present disclosure provides a method to stabilize bran or to convert rancid bran to sweet bran. Hydroxide or other base is used to saponify fatty acids to salts, and sulfite is used to remove autooxidation products, such as ketones and aldehydes. As used herein “fatty acid” refers to free fatty acids or fatty acids in glycerol acyl esters, such as fatty acid esters. In some embodiments, the amount of hydroxide used is not sufficient to convert all fatty acid esters but rather to address the release of free fatty acids. Therefore, the bran may still contain triglycerides of bran oil but any free fatty acids are saponified via the added hydroxide, thereby allowing the resultant bran to be extracted and increasing its value as a source of bran oil. This treatment also severely retards mold production, even at moisture levels of as high as 20%, thereby providing longer storage times in highly humid environs. Optionally, the bran may be treated with a protease, which permanently disables lipase activity, providing bran that is more stable than any commercially available bran.

Specifically, the present disclosure provides a method for treating untreated rice bran to produce a treated rice bran that is resistant to spoliation. This method comprises inactivating lipase in the untreated rice bran by heating the untreated rice bran to between about 40° F. and about 360° F., such as between about 40° F. and about 211° F., between about 60° F. and about 180° F., or between about 260° F. and about 340° F. At temperatures above about 211° F., the rice bran is not burned because the pressure and impact of the steam jacket and the relatively short exposure time. Alternatively, the lipase may be deactivated by treating the untreated rice bran with a protease, which digests the lipase. A food-grade hydroxide is added in an amount sufficient to have a pH ranging between about 7.5 and about 14.0, with the food-grade hydroxide contacting the untreated rice bran for between about 0.1 minutes and about 90 minutes, whereby fatty acids in the untreated rice bran are saponified to fatty acid salts. The untreated rice bran is also contacted with a source of bisulfite anions so that any aldehyde or ketone in the bran forms an organosulfite. The water is separated from the treated rice bran, whereby the treated rice bran is dried and available for consumption. The resultant treated rice bran is substantially free of aldehydes and ketones, and the majority of free fatty acid compounds within the treated rice bran will be fatty acid salts. The treated rice bran will have a moisture level of less than about 20% by weight, such as from about 20% by weight to about 6% by weight, or from about 10% to about 6% by weight. The untreated rice bran may be rancid or fresh, either is acceptable for use in the present disclosure. The method may further comprise drying the treated rice bran.

The food-grade hydroxide or other food-grade base may be added to the rice bran in an amount and for long enough to convert free fatty acids to fatty acid salts. The food-grade hydroxide may be selected from potassium hydroxide, sodium hydroxide, ammonium hydroxide, or divalent hydroxide salts, such as magnesium hydroxide or calcium hydroxide. The food-grade hydroxide may be added to the rice bran until the bran-hydroxide mixture has a pH of about 10.0 for about 30 minutes. Once converted, the method may further comprise adding a food-grade acid to the rice bran in an amount sufficient to have a pH of between about 5.0 and about 8.0 to neutralize excess base used in a previous step and to make the composition more palatable. In particular, the food-grade acid may be added to the bran-hydroxide mixture until the pH reaches about 6.5. Neutralization may occur simultaneously with bisulfite addition but must occur after the saponification reaction is complete. The bran-to-water ratio may be about 1:1 to about 1:10 by weight, such as about 1:5 by weight.

The source of bisulfite anions may be a metabisulfite species, an aqueous solution of hydrated bisulfite, such as an aqueous solution of ammonium metabisulfite or alkali bisulfite, specifically sodium bisulfite or potassium bisulfite, or any combinations of the foregoing. In some embodiments, the source of bisulfite anions may be an alkali metabisulfite, an aqueous solution of hydrated bisulfite, or combinations thereof. The bisulfite anion concentration in the aqueous solution may be between about 0.0001% and about 20% by weight of the untreated hydrated bran mixture, such as between about 1% and about 9%. The treated hydrated bran composition is substantially free of aldehydes and ketones. Residual bisulfite provides for the shelf life extension depicted in FIG. 3.

In some embodiments, this disclosure also provides a method for converting rancid rice bran to palatable rice bran. Fatty acids found in the rancid rice bran are converted to salts of fatty acids. Conversion comprises adding an amount of food-grade hydroxide to rancid rice bran to achieve a resultant pH of between about 7.5 and about 14.0, with such pH sufficient to saponify the fatty acids to fatty acid salts. The rancid rice bran is also contacted with a source of bisulfite anions to form an organosulfite from an aldehyde or a ketone within the hydrated rice bran. The palatable bran has the same amount of fiber and proteins as the rancid rice bran, with fatty acid salts and not ketones or aldehyde.

The present disclosure also provides a treated rice bran composition, comprising fatty acid salts, inactivated lipase, organosulfites, between about 14% and about 16% by weight protein, and between about 8% and about 10% by weight fiber. The treated rice bran composition may have a pH between 5.0 and 8.0, and/or water content of between 6% by weight to 20% by weight. The treated rice bran composition may be produced by any method described herein.

The present disclosure further provides rice bran admixture, comprising rice bran water in a bran-to-water ratio of about 1:1 to about 1:10 by weight, an amount of food-grade hydroxide sufficient for the rice bran admixture have a pH of between about 7.5 and about 14.0, and between about 0.0001% and about 1.25% by weight of bisulfite. The rice bran may be treated before it enters the admixture. For example, the rice bran may have been treated with a protease before entering the admixture. Generally, the rice bran admixture may be formed in the course of one or more methods described herein.

The present disclosure also provides a method for treating untreated rice bran to produce a treated rice bran. In this method, the untreated rice bran is fed into a cooker. Within the cooker, a temperature of between about 40° F. and about 360° F. is applied within the cooker. A food-grade hydroxide is added to the cooker in an amount sufficient to have a pH ranging between about 7.5 and about 14.0, with the food-grade hydroxide contacting the untreated rice bran for between about 0.1 minutes and about 90 minutes, whereby the fatty acids in the untreated rice bran are saponified to fatty acid salts. The untreated rice bran is also contacted within the cooker with a source of bisulfite anions so that an aldehyde or ketone in the untreated rice bran forms an organosulfite. By this method, the treated rice bran is produced, wherein the amount and characterization of protein and fiber between the treated rice bran and the untreated rice bran remain unchanged. In exemplary embodiments, the method is a continuous process. The cooker may be selected from one or more in the group consisting of expander, extruder, expeller, and combinations thereof, particularly an expander. The treated rice bran may exit the cooker at a temperature ranging between about 265° F. and about 380° F., such as between about 300° F. and about 350° F., or at about 325° F. Other variations to this method and the other methods would be readily understood by one of skill in the art in view of the present disclosure.

### BRIEF DESCRIPTION OF THE DRAWINGS

In addition to the exemplary aspects and embodiments described above, further aspects and embodiments will become apparent by reference to the drawings and by study of the following descriptions.

FIG. 1 depicts a continuous process for producing sweet bran in accordance with the present disclosure.

FIG. 2 depicts a batch process for producing sweet bran in accordance with the present disclosure.

FIG. 3 depicts the effect of metabisulfite concentration upon n-hexanal production in rice bran as a function of time. The n-hexanal was measured in milliequivalents per kilogram.

### DETAILED DESCRIPTION

The present disclosure may be understood by reference to the following detailed description, taken in conjunction with the drawings as described above. It is noted that, for purposes of illustrative clarity, certain elements in various drawings may not be drawn to scale, may be represented schematically or conceptually, or otherwise may not correspond exactly to certain physical configurations of embodiments.

The present disclosure provides a method for treating untreated rice bran to produce treated rice bran that does not readily spoil because it is substantially free of fatty acid esters. This method comprises inactivating the lipases in the rice bran, either by thermal or enzymatic treatment. After inactivation, the untreated rice bran is treated to convert fatty acids to fatty acid salts. In some embodiments, the rice bran can be simultaneously treated with base while using a cooker to stabilize the mix. The cooker may be selected from one or more in the group consisting of expander, extruder, expeller, and combinations thereof. In exemplary embodiments, the cooker is an expander. In other exemplary embodiments, the cooker is an expander-extruder, such as an Anderson Exapander-Extruder-Cooker™

The rice bran is also contacted, either stepwise or simultaneously, with a source of bisulfite anions so that aldehydes or ketones in the rice bran form organosulfites. Finally, water is separated from the rice bran, which may optionally include an active drying step. The resultant treated rice bran maintains the fiber and protein content of the untreated bran and is substantially free of fatty acid esters, ketones, and aldehydes.

When harvested from a field, a hull envelops the cereal grain. To make it suitable for human consumption, each particular type of grain must be milled After being dried, the grain is milled to remove the hull, yielding, for example, brown rice. In a second stage of milling, the outer brown layer is removed from the rice kernel to yield polished or white rice. As such, bran is the fibrous residue remaining from the milling process. Depending on the milling techniques, the bran may include part of the germ or endosperm, and may be mixed with part of the hull.

Brans from different types of grains are of similar composition. For example, the composition of rice bran (in percent by weight) ranges between about 11% and about 13% water, between about 18% and about 21% crude fat and oil, between about 14% and about 16% (crude) protein, between about 8% and about 10% (crude) fiber, between about 9% and about 12% ash, and between about 33% and about 36% carbohydrate.

Under normal milling conditions (ambient temperatures above freezing), the bran degrades into an unpalatable material, which is not suitable as a human food. Such degradation typically takes between six hours and two days. Degradation depends on time and temperature, as enzyme activity is impacted largely by temperature. Because of the problems associated with rancidity, most bran is used as feed for animals. Beyond three days, the bran is largely unpalatable, even to livestock.

### I. Lipase Deactivation

The method of the present disclosure is initiated by obtaining an amount of bran. As stated above, any type of grain-based bran material may be used, including rice bran, oat bran, barley bran, corn bran, or wheat bran. In exemplary embodiments, the bran is rice bran. Any amount of bran may be treated according to the present method. The only practical limitation is the size of the vessel in which the bran is treated. An amount of bran ranging between 1 pound and 10,000 pounds may typically be treated. Note that the present process can be a batch, continuous, or continuous batch process, dependent upon the particular equipment available.

An amount of water is added to the bran sufficient to hydrate the bran. The water may be distilled or tap water. For example, a soup-like mixture is formed, whereby the bran is covered with water. Essentially, the bran is fully hydrated. The bran-to-water ratio can and will vary. In some embodiments, the bran-to-water ratio may be from about 1:1 to about 1:10 by weight, such as from about 1:1 to about 1:2 by weight, from about 1:2 to about 1:3 by weight, from about 1:3 to about 1:4 by weight, from about 1:4 to about 1:5 by weight, from about 1:5 to about 1:6 by weight, from about 1:6 to about 1:7 by weight, from about 1:7 to about 1:8 by weight, from about 1:8 to about 1:9 by weight, or from about 1:9 to about 1:10 by weight. In some embodiments, the bran-to-water ratio may be less than 1:6 by weight. In other embodiments, the bran-to-water ratio may be greater than 1:4 by weight. In exemplary embodiments, the bran-to-water ratio may be about 1:5 by weight. In a particular embodiment, the ratio is a 1:5 mix of 1 part by weight bran to 5 parts by weight water.

The lipases in the bran are inactivated. Inactivation may be thermal, enzymatic, or both. For thermal inactivation, the water and bran mixture is heated. The range of temperatures can and will vary. In some embodiments, the temperature may range from between about 40° F. and about 360° F., such as between about 40° F. and about 211° F., between about 40° F. and about 60° F., between about 80° F. and about 100° F., between about 100° F. and about 120° F., between about 120° F. and about 140° F., between about 140° F. and about 160° F., between about 160° F. and about 180° F., between about 170° F. and about 190° F., between about 180° F. and about 211° F., between about 180° F. and about 220° F., between about 220° F. and about 240° F., between about 240° F. and about 260° F., between about 260° F. and about 280° F., between about 280° F. and about 300° F., between about 300° F. and about 320° F., between about 320° F. and about 340° F., or between about 340° F. and about 360° F. In some embodiments, the temperature may be less than 190° F. In other embodiments, the temperature may be more than 170° F. In one embodiment, the temperature is between about 60° F. and about 180° F. In another embodiment, the temperature is between about 120° F. and about 140° F. In a particular embodiment, thermal lipase deactivation occurs at about 180° F. In a yet another embodiment, thermal lipase deactivation occurs between about 260° F. and about 340° F. The bran must not be heated under conditions where it is cooked or a Maillard reaction (browning) or burning occurs. The bran material should be sufficiently heated so that the reaction speed is increased, but the flavor, taste, and nutritional value of the resultant product are not substantially impacted. In particular, the amount and characterization of protein and fiber between the treated rice bran and the untreated rice bran remain unchanged.

Generally, the duration of heating depends on the temperatures. For example, heating at 180° F. lasts about 35 seconds to about 60 seconds. The duration of heating can and will vary. In some embodiments, the duration may range from about 5 seconds to about 120 seconds, for example from about 5 seconds to 15 seconds, from about 15 seconds to 30 seconds, from about 30 seconds to 45 seconds, from about 45 seconds to 60 seconds, from about 60 seconds to 75 seconds, from about 75 seconds to 90 seconds, from about 90 seconds to 105 seconds, or from about 105 seconds to 120 seconds. In some embodiments, the duration may longer than 35 seconds. In other embodiments, the duration may be shorter than 60 seconds.

Alternatively, the lipase in the bran may be treated with a protease to remove lipase activity. The protease may be a mixture of endo- and exoproteases, or may be non-specific protease, such as Genencor® Protex™ 6L. The activity of the protease may be about 500,000 DU/g to about 600,000 DU/g. The ratio of protease to bran may be about 40 pounds of protease per 50,000 pounds of untreated hydrated bran at a temperature about 130° F. to about 140° F. for about 35 minutes to about 60 minutes at a pH 4.0. One of skill in the art would understand how to adjust the ratio, time, temperature, and pH the treatment with a selected protease. See, for example, U.S. Patent Application Publication No. 2003/00082290, which is incorporated herein by reference in its entirety.

### II. Saponification

Saponification requires adding a base, for example a food-grade hydroxide; however, other bases may also be used. The food-grade hydroxide may be selected from potassium hydroxide (KOH), sodium hydroxide (NaOH), ammonium hydroxide (NH₄OH), or divalent hydroxide salts, such as magnesium hydroxide (Mg(OH)₂) or calcium hydroxide (Ca(OH)₂), or any combination of the foregoing. Any base that raises the pH of the bran mixture to between about 7.5 and about 14, for example to a pH between about 8.5 and 11.0, may be used. In some embodiments, a pH of approximately 10 may be achieved. The amount of base added depends upon the amount of bran being treated, but must be sufficient to achieve the desired pH. Also, the molar concentration of the base will impact how much is added.

Generally, this bran mixture is heated prior to, or during, the addition of the base. Again, the temperature of the water and bran mixture will range between about 40° F. and 211° F. during the time of the reaction with the base. In some embodiments, the temperature may range from between about 40° F. and about 211° F., such as between about 40° F. and about 60° F., between about 80° F. and about 100° F., between about 100° F. and about 120° F., between about 120° F. and about 140° F., between about 140° F. and about 160° F., between about 160° F. and about 180° F., between about 170° F. and about 190° F., or between about 180° F. and about 211° F. In some embodiments, the temperature may be less than 190° F. In other embodiments, the temperature may be more than 170° F. In one embodiment, the temperature is between about 60° F. and about 180° F. In another embodiment, the temperature is between about 120° F. and about 140° F. In exemplary embodiments, the temperature may range between 120° F. and 140°F.

Generally, the reaction time can and will vary. In some embodiments, the reaction time may range from about 0.1 minutes to about 90 minutes, for example from about 5 minutes to 15 minutes, from about 15 minutes to 30 minutes, from about 20 minutes to 35 minutes, from about 30 minutes to 45 minutes, from about 45 minutes to 60 minutes, from about 60 minutes to 75 minutes, or from about 75 minutes to 90 minutes. In some embodiments, the duration may be from about 15 minutes to 45 minutes. In other embodiments, the duration may longer than 20 minutes. In other embodiments, the duration may be shorter than 60 minutes. In exemplary embodiments, the reaction time is about 30 minutes.

In exemplary embodiments, the saponifying step comprises adding a food-grade hydroxide to the untreated hydrated rice bran in an amount sufficient to have a pH ranging between about 7.5 and about 14.0, with the food-grade hydroxide contacting the bran for between about 0.1 minutes and about 90 minutes.

In other exemplary embodiments, the saponifying step comprises adding a food-grade hydroxide to the untreated hydrated rice bran in an amount sufficient to have a pH ranging between about 8.5 and about 11.0, with the food-grade hydroxide contacting the bran for between about 15 minutes and about 45 minutes.

In yet other exemplary embodiments, the saponifying step comprises adding a food-grade hydroxide to the untreated hydrated rice bran in an amount sufficient to have a pH of about 10.0 for about 30 minutes.

Contact between the base and the bran should be sufficient to convert the fatty acids found in the bran to salts of the fatty acids. In some embodiments, the amount of hydroxide used is not sufficient to convert all fatty acid esters but rather to address the release of free fatty acids. Therefore, the bran may still contain triglycerides of bran oil but any free fatty acids are saponified via the added hydroxide, thereby allowing the resultant bran to be extracted and increasing its value as a source of bran oil. Thus, the reaction will convert most of the fatty acids, typically triglycerides, to salts of fatty acids and glycerol. In particular, short-chain fatty acids of C₂ to C₁₂ are saponified. These short-chain fatty acids are more volatile than longer-chained fatty acids and have more negative sensory attributes. Short-chain fatty acids comprise about 15% of the fat present in bran.

The saponification reaction is illustrated as follows:

(C₁₇H₃₅COO)₃C₃H₅+3NaOH→3C₁₇H₃₅COONa+C₃H₅(OH)₃

Next, the pH of the bran mixture is optionally reduced to between about 5.0 to about 8.0, to between about 6.5 to about 8.0, or to approximately 7.0 by the addition of acid. Food-grade acid, such as hydrochloric acid (HCl), phosphoric (H₃PO₄), acetic acid (CH₃COOH), or combinations thereof is used. Other food-grade acids may be used, as long as the pH is sufficiently lowered. The acid is added to bring the mixture back to neutral. While the present step is preferred, it is not required. The pH of the treated bran depends only upon the final use of the bran. The molar ratio of food-grade acid to treated bran depends on the amount of residual food-grade base present in the treated bran. Titration and other methods known in the art may be applied to determine sufficient amounts. Neutralization may occur simultaneously with bisulfite addition but must occur after the saponification reaction is complete. In other words, after the saponifying step and commensurate with the bisulfite step, a food-grade acid may be added to the untreated rice bran in an amount sufficient to obtain a pH of between about 5.0 and about 8.0, such as about 6.5 or 7.0.

This reduction or elimination of free fatty acids from the bran provides stability by removing the substrates, which the lipase and lipoxygenase enzymes attack. A further advantage of this treatment is that it converts naturally occurring free fatty acids into stable salts, which do not have an odor of their own and do not react on their own with the lipoxygenase or other enzymes.

After the addition of the acid, the bran product may be pasteurized to further destroy microbial activity. Pasteurization is not required, but it is preferred. Alternatively, after processing, proteases, xylanases, or other enzymes may be added to the bran.

### III. Removing Autooxidation Products

Rancidity may negatively impact the palatability of fat- and oil-containing livestock feed and companion animal food raw materials long before there is a negative impact upon nutritional value. In particular, the oxidation of unsaturated fatty acids is a major contributor to the formation of hexanal, a product of the partial oxidation of alcohol groups. These alcohol groups arise from the natural oxidation of polyunsaturated fats and oils. This process may be monitored by the formation of peroxides and evaluated through the measurement of peroxide values (PV).

In the normal course of oxidation, the unsaturated carbon-carbon bond of an unsaturated fatty acid is attacked by oxygen, forming peroxides. The peroxides, after several additional steps, form aldehydes and ketones of various chain lengths. Aldehydes of importance include pentanal, hexanal and heptanal. The aldehyde of particular interest is that of hexanal as it is a well-known flavor compound that is a negative palatant to many animals, including dogs and cats.

At present, unsaturated fatty acid-containing feed- and food-grade raw materials must be discarded if aldehyde and ketone levels are sufficiently high to negatively impact palatability, even if nutritional value is unaffected. To do otherwise, risks the resulting product gaining a negative reputation among purchasers. Thus, considerable cost savings may be attained if a means by which objectionable aldehydes and ketones could be removed were available so nutritious raw materials that would otherwise be discarded could be used.

The oxidation of unsaturated fatty acids to form aldehydes such as pentanal, hexanal and heptanal is also a problem in the manufacture and preparation of food products for human consumption. One example is the cooking oil in which foods are fried. Cooking oils rapidly oxidize to form objectionable aldehydes and ketones, which impact negatively on palatability by detracting from flavor and other organoleptic properties. Commercial food manufacturers and eating establishments must frequently replace otherwise good cooking oil because small quantities of aldehydes and ketones form in levels sufficient to result in a food product that is generally unacceptable to the consuming public. Considerable cost savings could be attained if a means by which such cooking oil could be reclaimed was available.

As disclosed herein, the well-described pathway for converting aldehydes and ketones with bisulfites to organosulfite salts may be adapted to convert volatile aldehydes and ketones to non-volatile organosulfites in bran containing oxidizable unsaturated fatty acids, thereby overcoming a major hurdle to improving the palatability of bran products.

Bran, whether freshly milled or oxidized, is contacted with source of bisulfite anions. The bran contains unsaturated fatty acids that have oxidized to form aldehydes and ketones having a negative impact on palatability, such as pentanal, hexanal and heptanal, especially hexanal. Bisulfite breaks the lipid oxidation chain, leading to the discovery that it can be used to attack peroxide and replace it with a sulfonate, thus causing peroxide levels to decrease. Bisulfite breaks the disulfide bond of cysteine and relaxes proteins, leading to the discovery that it may be used against key enzymes, such as lipase, to result in their denaturation and inactivation.

Bran products are contacted with the source of bisulfite anions so that the aldehydes and ketones form organosulfite salts with no negative impact upon palatability. For purposes of the present disclosure, contact with bisulfite anion source occurs either by contact of a moist or dry feed or food product with an aqueous solution of hydrated bisulfite, or by contact of dry metabisulfite with a feed or food product with sufficient moisture to dissolve the metabisulfite and form bisulfite anions.

The contacting step may be performed by adding dry metabisulfite to a bran composition exposed to sufficient moisture during blending or steam conditioning to form bisulfite anions, or an aqueous solution of hydrated bisulfite may be added to the expander, extruder, expeller, or sprayed on the surface of the bran product after expansion to soak therein and convert any aldehydes or ketones present to organosulfites. Any configuration allowing for the thorough admixture of bran composition with bisulfite anions and water is suitable for use with the present disclosure, including the addition of aqueous bisulfite solutions during blending or steam conditioning. The method may also be applied to moist or cooked bran compositions.

Of the dry metabisulfites added to products with sufficient moisture, alkali metabisulfites may be used, with sodium or potassium metabisulfite in some exemplary embodiments. Generally, aqueous bisulfite solutions suitable for use with the present disclosure contain between about 0.0001 wt. % and about 20 wt. % hydrated bisulfite. The range of concentrations of bisulfite used in the present disclosure can and will vary. In some embodiments, the concentration of bisulfite may be between about 0.0001 wt. % and about 0.001 wt. %, between about 0.001 wt. % and about 0.01 wt. %, between about 0.01 wt. % and about 0.1 wt. %, between about 0.1 wt. % and about 0.5 wt. %, between about 0.5 wt. % and about 1 wt. %, between about 1 wt. % and about 2 wt. %, between about 2 wt. % and about 3 wt. %, between about 3 wt. % and about 4 wt. %, between about 4 wt. % and about 5 wt. %, between about 5 wt. % and about 6 wt. %, between about 6 wt. % and about 7 wt. %, between about 7 wt. % and about 8 wt. %, between about 8 wt. % and about 9 wt. %, between about 9 wt. % and about 10 wt. %, between about 10 wt. % and about 11 wt. %, between about 11 wt. % and about 12 wt. %, between about 12 wt. % and about 13 wt. %, between about 13 wt. % and about 14 wt. %, between about 14 wt. % and about 15 wt. %, between about 15 wt. % and about 16 wt. %, between about 16 wt. % and about 17 wt. %, between about 17 wt. % and about 18 wt. %, between about 18 wt. % and about 19 wt. %, or between about 19 wt. % and about 20 wt. In some embodiments, the concentration of bisulfite may be more than 1 wt. %. In other embodiments, the concentration of bisulfite may be less than 9 wt. %. In some exemplary embodiments, the concentration may be between about 1 wt. % and about 9 wt. %. The use of fresh solutions is also exemplary.

The bran compositions are contacted with an amount of the bisulfite anion source that, depending upon the extent of oxidation, will improve palatability. This can be readily determined by one of ordinary skill in the art without undue experimentation, typically with reference to the peroxide value of the bran composition. The amount is a quantity that restores the bran composition to a usable state or would substantially prevent the bran product from oxidizing to an unusable state. “Usable state” herein is defined as product that passes in commerce without customer objection, which refers to the satisfaction of purchasers with respect to consumption of product.

If too little bisulfite is used, the contacting step may be repeated until a non-objectionable product is obtained. The bran composition is contacted with a source of bisulfite anions effective to provide between slightly less and slightly more than a stoichiometric equivalent of bisulfite. Slightly less than a stoichiometric equivalent still produces an unobjectionable product. Residual bisulfite may negatively impact palatability. Therefore, any stoichiometric excess should not produce a negative impact upon palatability. This may also be readily determined by one of ordinary skill in the art without undue experimentation, typically with reference to residual analysis of bisulfite.

Accordingly, bran products are prepared by contact with a quantity of dry metabisulfite or aqueous bisulfite solution that adds to the products an amount of bisulfite anions effective to convert at least 70% by weight of volatile ketones and aldehydes to organosulfites, for example at least 80% by weight of volatile ketones and aldehydes to organosulfites, at least 90% by weight of volatile ketones and aldehydes to organosulfites, at least 95% by weight of volatile ketones and aldehydes to organosulfites, or at least 99% by weight of volatile ketones and aldehydes to organosulfites. Typically, between about 0.0001% and about 1.25% by weight of bisulfite is added to the bran composition, most or all of which is then converted to organosulfite. The concentration of bisulfite added can and will vary. In some embodiments, the concentration of bisulfite added may be between about 0.0001 wt. % to about 0.0005 wt. %, between about 0.0005 wt. % to about 0.001 wt. %, between about 0.001 wt. % to about 0.005 wt. %, between about 0.005 wt. % to about 0.01 wt. %, between about 0.01 wt. % to about 0.02 wt. %, between about 0.02 wt. % to about 0.025 wt. %, between about 0.025 wt. % to about 0.03 wt. %, between about 0.03 wt. % to about 0.04 wt. %, between about 0.04 wt. % to about 0.05 wt. %, between about 0.05 wt. % to about 0.06 wt. %, between about 0.06 wt. % to about 0.07 wt. %, between about 0.07 wt. % to about 0.08 wt. %, between about 0.08 wt. % to about 0.09 wt. %, between about 0.09 wt. % to about 0.1 wt. %, between about 0.1 wt. % to about 0.15 wt. %, between about 0.15 wt. % to about 0.2 wt. %, between about 0.2 wt. % to about 0.3 wt. %, between about 0.3 wt. % to about 0.4 wt. %, between about 0.4 wt. % to about 0.5 wt. %, between about 0.5 wt. % to about 0.6 wt. %, between about 0.6 wt. % to about 0.7 wt. %, between about 0.7 wt. % to about 0.8 wt. %, between about 0.8 wt. % to about 0.9 wt. %, between about 0.9 wt. % to about 1.0 wt. %, between about 1.0 wt. % to about 1.1 wt. %, or between about 1.1 wt. % to about 1.25 wt. %. In some embodiments, less than 0.9 wt. % bisulfite is added to the products. In some embodiments, less than 0.09 wt. % bisulfite is added to the products. In other embodiments, more than 0.01 wt. % bisulfite is added to the products. In exemplary embodiments, between about 0.1% and about 0.9% by weight of bisulfite is added to the products. In other exemplary embodiments, between about 0.6% and about 0.8% by weight of bisulfite is added to the products. In some other exemplary embodiments, between about 0.01% and about 0.2% by weight of bisulfite may be added to the product. In still other exemplary embodiments, between about 0.015% and about 0.025% by weight of bisulfite may be added to the products.

The bran composition may be washed with an aqueous bisulfite solution so that organosulfites formed from any aldehydes or ketones present dissolve in the aqueous solution, after which the bran composition is separated from the aqueous solution. The bisulfite solution may be added to the expander/extruder/expeller throat with bran and food-grade hydroxide. Contract time depends on the length of the extruder screw and the temperature. For example, a three-foot screw takes about 30 seconds at about 315° F. or higher. The recovered raw materials are optionally washed with water to remove residual organosulfites and bisulfites. After the bran composition has been removed from the aqueous solution, the aqueous solution may be acidified by conventional means to regenerate the aldehyde or ketone and bisulfite. Conventional solvent extraction techniques, such as washing the aqueous solution with ether, may be used to separate the regenerated aldehyde or ketone from the aqueous solution.

The regenerated bisulfite solution may then be reused, either to wash the same quantity of raw materials a second time, or to wash a new quantity of raw material. The regenerated solutions can be used in a series of batch processes, or the solution regeneration may be part of a continuous process in which regenerated bisulfite solution is continuously delivered to a constant supply of raw material. In a continuous process, water or bisulfite may be periodically replenished to maintain an essentially constant solution concentration.

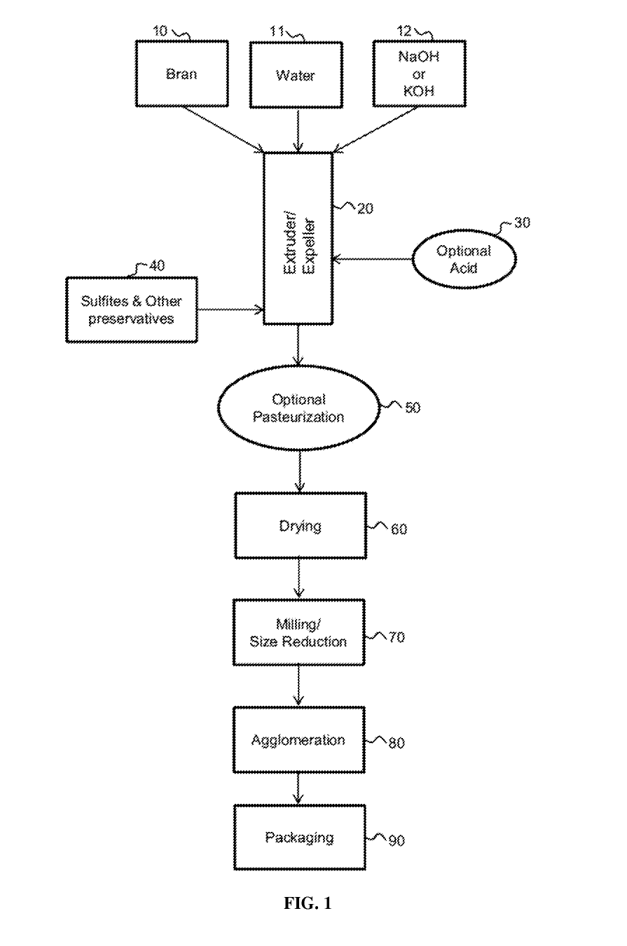

Referring to FIG. 1, the continuous process for treating bran involves introducing bran 10 at a rate of about 80 to about 95 lbs/hour with water 11 and NaOH/KOH 12 at a rate of about 5 to about 20 lbs/hour into an expander/extruder/expeller 20 to form a hydrated bran composition. The relative rates between 10 and 11,12 are selected to achieve a target pH of the mixture to effect saponification of fatty acids in the bran 10.

The expander/extruder/expeller 20 is heat-jacketed to achieve a product temperature of about 325° F. Treatment time of the hydrated bran composition is about 30 seconds. Optional acid 30 may be added to the expander/extruder/expeller 20 to neutralize the solution to a pH of about 6 to about 8 after saponification is complete. Sulfites and other preservatives 40 may also be added at a concentration of about 0.01% to about 0.1% to control autooxidation. After leaving expander/extruder/expeller 20, the saponified bran may be optionally pasteurized 50. At this point, the bran composition may have a moisture percent of about 12% to about 24%. Following drying 60, the finished moisture is about 12% to about 18%. After drying 60, the bran composition is milled 70, agglomerated 80, and packaged 90, as is described below in Section IV.

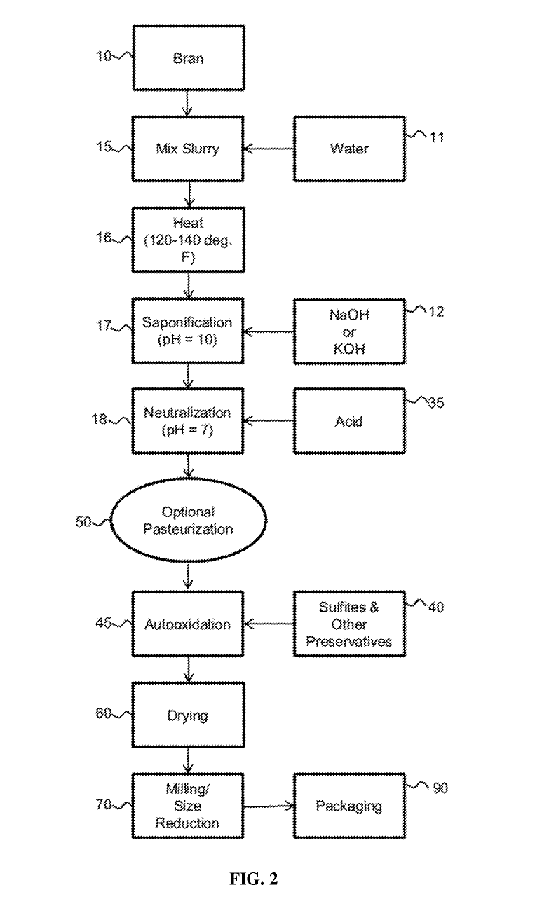

The process for producing sweet bran may also be performed in batches. Referring to FIG. 2, bran 10 is mixed with water 11 to form a slurry 15, for example with a bran-to-water ratio of about 1:5 (wt./wt.), such as 16 pounds of bran to 84 pounds of water. The slurry 15 is heated 16 to a temperature of about 120° F. to about 140° F. for a period of time sufficient to deactivate native lipases in the bran 10. Next, the bran composition is saponified 17 at a pH of about 10 using NaOH or KOH 12. Following saponification 17, the bran composition is neutralized 18 to a pH of about 7 using acid 35. Optionally, the bran composition is pasteurized 55. Autooxidation 45 of the saponified bran composition is inhibited by addition of sulfites and other preservatives 40. The bran composition is dried 60 from a moisture content of about 80% to a moisture content of about 12% to about 80%. The dried bran composition is then milled 70 and packaged 90.

### IV. Drying and Making the Final Bran Product

The bran material is optionally dehydrated, or dried, to achieve a total moisture content of about 6 wt. % to about 14 wt. %, such as about 7 wt. %. The amount of moisture in the bran material can and will vary. In some embodiments, the total moisture content may be about 20 wt. %, about 15 wt. %, about 14 wt. %, about 13 wt. %, about 12 wt. %, about 11 wt. %, about 10 wt. %, about 9 wt. %, about 8 wt. %, about 7 wt. %, about 6 wt. %, about 5 wt. %, about 4 wt. %, about 3 wt. %, about 2 wt. %, or about 1 wt. %. In some embodiments, the total moisture content is less than 10%. In other embodiments, the total moisture content is greater than 1%.

Generally, the amount of moisture remaining in the bran depends on the final use of the product, whether preservatives are added, or whether other steps will be taken to preserve the quality of the bran. The wet stabilized bran may be dried by air drying, oven drying, vacuum drying, freeze drying, or any drying process which will produce a dried product. Any kind of dryer may be selected based on operating costs and other properties. Examples of suitable dryers include, but are not limited to, open-walled dryers, rotary drum dryers, and angled dryer baskets. When using a drum dryer, the angle of the dryer may be selected to control the drying time.

The dried product has a moisture content, which ranges between about 6% to about 10% by weight, and can be stored for long periods of time without deterioration. Dried, stabilized bran product can be rewetted for further processing, or used as an ingredient in various food or food products.

Generally, the treated rice bran may exit the cooker at a temperature ranging between about 265° F. and about 380° F. The range of exit temperatures of the treated rice bran can and will vary. In some embodiments, the treated rice bran may exit the cooker at a temperature ranging between about 265° F. and about 275° F., between about 275° F. and about 300° F., between about 300° F. and about 325° F., between about 325° F. and about 350° F., between about 350° F. and about 375° F., between about 375° F. and about 380° F. In some embodiments, the treated rice bran may exit the cooker at a temperature above about 265° F. In other embodiments, the treated rice bran may exit the cooker at a temperature below about 380° F. In exemplary embodiments, the temperature ranges between about 300° F. and about 350° F. In other exemplary embodiments, the temperature is about 325° F.

A homogenous mixture may be formed from wet and dry ingredients mixing the wet ingredients with all or some of the dry ingredients in a mixer. The mixture is dried by evaporation or lyophilization, for example, to form a dry, powdery bran composition that is then blended with any remaining dry ingredients in a tumbler until a homogeneous mixture is formed.

The resultant bran may be used in beverages, supplements, doughs, and any product requiring improved nutritional quality. The resultant bran maintains the same caloric content as untreated bran with the nascent proteins still intact. Nearly all available fatty acid compounds are converted to salts of fatty acids. The bran has lipase activity, but no available substrates. As such, the caloric content of the bran remains unchanged. Also, rancid bran with an increased number of fatty acids may be saponified to restore its palatability.

### V. Applications to Human Food and Animal Feed

A. Feed Compositions

The finished bran may be used as a feed or food ingredient for numerous applications, either directly or in combination with other ingredients. The finished bran may be used to form feed products, especially for companion animals. Livestock feed and companion animal food products are typically formed as a dry or semi-dry expanded/extruded/expelled kibble. Any bite-sized piece of a dry or semi-dry livestock feed or companion animal pet food is referred to as a kibble, including those that may also be referred to as a pellet or by any other descriptive term.

Companion animal dry and semi-dry foods generally relate to a nutritionally balanced mixture of proteinaceous and farinaceous materials having moisture contents of about 50% or less by weight. Companion animal moist food products generally relate to a nutritionally balanced mixture of proteinaceous and farinaceous materials having moisture contents above 50% by weight. In moist food products, the proteinaceous and farinaceous materials are typically formed into a solid mass with a hydrocolloid such as gelatin. The meat in moist food products can be supplied by chunks of actual meat or by reformed, emulsified meat and meat byproducts. Companion animal moist food may also optionally include a gravy component prepared from hydrocolloids and flavorings, and for this reason bisulfites are added to the meat component.

The companion animal food compositions described herein are not limited to a specific listing of ingredients because such ingredients will depend on such factors as, for example, the desired nutritional balance for the specific type of companion animal, and availability of ingredients to the manufacturer. The companion animal food composition may also include vitamins, minerals, and other additives such as flavorings, preservatives, emulsifiers, and humectants. The nutritional balance, including the relative proportions of vitamins, minerals, fat, protein and carbohydrate, is determined according to dietary standards known in the veterinary art. For example, the nutritional balance of a cat food composition is determined according to the known dietary requirements for cats.

Livestock feeds relate to grain and silage compositions and, like companion animal food products, also include vitamins, minerals, and other additives such as flavorings, preservatives, emulsifiers, and humectants. The nutritional balance, including the relative proportions of vitamins, minerals, fat, protein and carbohydrate, is determined according to dietary standards known in the large animal veterinary art.

Suitable proteinaceous material may include any material having a protein content of at least about 15% by weight including vegetable proteins such as soybean, cottonseed, and peanut; animal proteins such as casein, albumin, and fresh animal tissue including fresh meat tissue and fresh fish tissue; and dried or rendered meals such as fish meal, poultry meal, meat meal, bone meal, and the like. Other types of suitable proteinaceous materials include wheat gluten or corn gluten, and microbial proteins such as yeast.

Suitable farinaceous material may comprise any material having a protein content of less than about 15% by weight and containing a substantial proportion of starches or carbohydrates, including grains such as corn, milo, alfalfa, wheat, barley, rice, soy hulls, and other grains having low protein content. In addition to the proteinaceous and farinaceous materials, other materials such as whey and other dairy byproducts, as well as other carbohydrates may be added. In addition, known flavorings including, for example, corn syrup or molasses, may be added.

Generally, the terms “livestock feed composition” and “companion animal food composition” as used herein apply to commercially sold, nutritionally-balanced compositions that are intended to provide substantially the sole diet for livestock and companion animals. Thus, such compositions may be described as having minimum protein contents at which livestock and companion animal health is maintained. However, the minimum protein content of the food varies according to the age and breeding status for the animal.

For example, a nutritionally-balanced cat food composition for breeding females and kittens requires a minimum protein content of at least about 28% by weight on a dry matter basis. A nutritionally balanced cat food composition for non-breeding and adult cats requires a minimum protein content of about 26% by weight on a dry matter basis. More typically, the protein content of commercially available cat food compositions for adult, non-breeding cats is about 30% by weight on a dry matter basis, to insure that the food meets the nutritional requirements of any cat.

For example, a typical formula well known in the art for a dry companion animal food composition to which the source or bisulfite anions is applied is as follows:

0%-70% by weight grain-based meal or flour, such as corn, wheat, barley or rice;

0%-30% by weight animal by-product meal, such as poultry or beef meal;

0%-25% by weight corn gluten meal;

0%-25% by weight fresh animal tissue, such as poultry or beef tissue;

0%-25% by weight soybean meal or flour;

0%-25% by weight fresh fish tissue;

0%-20% by weight seafood-based meal;

0%-10% by weight animal fat;

0%-10% by weight high fructose corn syrup;

0%-10% by weight dried molasses;

0%-1.5% by weight phosphoric acid; and

0%-1.5% by weight citric acid.

Additionally, vitamins and minerals are added according to known American Association of Feed Control Officials (AAFCO) guidelines. Such AAFCO profiles include calcium carbonate, potassium chloride, sodium chloride, choline chloride, taurine, zinc oxide, ferrous sulfate, vitamin E, vitamin A, vitamin B₁₂, vitamin D₃, riboflavin, niacin, calcium pantothenate, biotin, thiamine mononitrate, copper sulfate, folic acid, and pyroxidine.

Livestock feeds are typically prepared from vegetable materials edible to ruminants, such as legume hay, grass hay, corn silage, grass silage, legume silage, corn grain, barley, oats, distiller's grain, brewer's grain, soybean meal and cottonseed meal. A typical formula well known in the art for a dry livestock food composition to which the source of bisulfite anions is applied is as follows:

0%-70% by weight grain-based meal or flour, such as corn, wheat, barley or rice;

0%-30% by weight animal by-product meal, such as poultry or beef meal;

0%-25% by weight corn gluten meal;

0%-25% by weight soybean meal or flour;

0%-20% by weight seafood-based meal;

0%-10% by weight animal fat;

0%-10% by weight high fructose corn syrup;

0%-10% by weight dried molasses;

0%-1.5% by weight phosphoric acid; and

0%-1.5% by weight citric acid.

Dry and semi-dry livestock feed and companion animal foods may be prepared by a variety of methods. One such method that is widely used on a commercial basis is the cooker-extruder method (e.g., using an expander, extruder, expeller, or a device which is a combination of the foregoing). In the cooker-extruder method, dry ingredients are first blended together to form an admixture. This admixture is transferred into a steam conditioner where it is sufficiently moistened to become extrudable. The admixture then enters a cooker/extruder where it is cooked at an elevated temperature and pressure for a short period of time and then forced out of the apparatus through a die. This die forms the extruded product into a specific shape.

Individual pieces of product are created by periodically slicing off the end of the expanded/extruded/expelled stream of product. The individual pieces, or kibbles, are then dried in a hot air dryer. Generally, the product is dried until it contains less than about 15 percent moisture, and about 9 to 12 percent moisture. The resulting pebbles or kibbles constitute the basal feed or food composition.

With dry and semi-dry companion animal food compositions, the dried particles or pieces are then transferred by bulk conveyor to a coating drum and sprayed with animal fat. Other liquids such as, for example, citric acid or phosphoric acid may alternatively be applied to the pieces, or may be applied with or in addition to the animal fat, during or after which a coating of the palatability enhancer is typically applied. The coating need not be a continuous layer, but may be uniform. After the fat cools, if not included with the fat coating, the palatability enhancer may be applied as either a dry power or a liquid, or both, while the product is mixing. A liquid palatability enhancer is typically sprayed on while a dry palatability enhancer is typically dusted on, through a mesh screen to make the application more uniform on the particles or pieces. Alternatively, a palatability enhancer can be mixed with the fat and applied concurrently. Note that multiple coatings may be applied to achieve uniformity of the coating.

Companion animal moist food products that are gravy-based are prepared by grinding meat, meat mimetics or meat byproducts and then forming the ground mixture via low-pressure extrusion through a steaming tunnel where it is cooked. Starch and binders are then added, after which the mixture is cut into pieces, mixed with water or gravy, sealed in cans and cooked in a hydrostat, continuous retort or rotary steritort.

Companion animal moist food products that are not gravy-based are prepared by macerating meat, meat mimetics or meat byproducts and reforming the macerated materials with water, starch, and binders. The mixture is then sealed in cans and cooked in a hydrostat, continuous retort or rotary steritort.

Semi-moist products are prepared by macerating and mixing meat, meat byproducts or meat mimetics, precooking the mixture, and then mixing the product with humectants such as glycerol, polysorbate, Tweens™, and Spans™ to hold water. The resulting mixture can be formed and put into a can or pouch for retorting or press-formed and cooked or retorted in a pouch.

“Meat” and “meat byproducts” are defined as including meat and meat byproducts from animal species and fish species. Examples of animal meat and meat byproducts for which palatability can be improved by the method of the present disclosure include, but are not limited to meat and meat byproducts derived from beef, pork, sheep or lamb, poultry, duck, and the like. Examples of fish products and fish by-products that can be used include, but are not limited to, products and byproducts derived from tuna, salmon, cod, whitefish, shrimp, and the like.

Examples of unsaturated animal and vegetable fats include animal fats such as tallow, chicken fat and lard and vegetable oils such as canola oil, sunflower oil, safflower oil, cottonseed oil, canola oil, linseed oil, soybean oil, olive oil, corn oil, and the like, and derivatives thereof. Examples of animal oils include marine oils and byproducts thereof, such as marine oils from sources such as menhaden, herring, mackerel, caplan, tilapia, tuna, sardine, Pacific saury, hill, salmon, anchovy, skate, whale, seal, crab, shrimp, lobster, eel, mollusk, and the like. Vegetable oils also include oils derived from marine vegetation such as algae, kelp and the like.

Methods according to the present disclosure add one or more feed- or food-grade antioxidants to the feed or food products to slow the subsequent production of the offending aldehydes and ketones. Suitable antioxidants include, but are not limited to, ethoxyquin, BHA, BHT, tertiary-butyl hydroquinone, propyl gallate, tocopherols, rosemary extracts, and the like. Quantities between about 0.01 ppm and about 1000 ppm should be used.

B. Kits

Kits may be assembled in which separate containers of a feed- or food-grade antioxidant and a metabisulfite species or aqueous bisulfite solution are distributed in combination. This promotes improvement of an overly oxidized product to a usable state and thereby improves palatability and stabilizes the resulting product by adding one or more antioxidants. Kits may have as a primary component in a separate container a palatability enhancing composition for bran products. The purpose of a three-container kit is to distribute metabisulfite and antioxidants with a palatability enhancing composition to remove offending aldehydes and ketones from oxidized raw materials and stabilize the raw materials against further oxidation before the raw materials are formulated with palatability enhancing compositions.

C. Palatability Enhancing Compositions

Palatability enhancing compositions contain one or more palatability enhancing compounds, examples of which include pyrophosphoric acid and the sodium, potassium, calcium and magnesium salts thereof, phosphoric acid and the sodium, potassium, calcium and magnesium salts thereof, sodium, potassium, calcium and magnesium tripolyphosphate salts, potassium, calcium and magnesium hexapolyphosphate salts, or organic acids such as citric, tartaric, fumaric, lactic, acetic, formic and hexamic acids and the sodium, potassium, calcium and magnesium salts thereof, and the like. Examples of suitable palatability enhancing compositions are disclosed in U.S. Pat. No. 7,244,460, the disclosure of which is incorporated herein by reference.

The palatability enhancers may contain from about 0.1% to 80% by weight of one or more palatability enhancing compounds, examples of which are listed above. Palatability enhancing compound levels between about 5% and about 50% by weight may be used, with levels between about 10% and about 35% by weight, or levels between about 15% and about 30% by weight.

The palatability enhancers are formulated and applied so that the one or more palatability enhancing compounds constitute from about 0.01% to about 5.0% by weight of the finished pet food product. The palatability enhancers are formulated so that the one or more palatability enhancing compounds constitute from about 0.05% to about 2.0% by weight of the finished pet food product, or between about 0.1% to about 1.0% by weight, or between about 0.25% and about 0.75 wt. %.

Palatability herein contain from about 0.01% to about 20% by weight of a source of bisulfite anions, for example with levels between about 1% and about 9% by weight. The palatability enhancers are formulated with a quantity of dry metabisulfite or aqueous bisulfite solution that adds between about 0.01% and about 1.25% by weight of bisulfite to the food product, most or all of which is then converted to organosulfite. Between about 0.01% and about 0.2% by weight of bisulfite may be added to the food product, for example a quantity between about 0.025% and about 0.15% by weight.

Palatability enhancers may further contain one or more feed or food grade antioxidants, examples of which are listed above, at a level effective to supply the food product with a level of antioxidant sufficient to stabilize the product against further aldehyde and ketone formation. A level between about 0.01% and 2.5% by weight in the palatability enhancing composition should be used, for example with a level between about 0.1% and about 1.0% by weight. The palatability enhancers are formulated with a quantity of antioxidant that adds between about 0.01 and about 1000 ppm of antioxidant to the food product. Among the same or other palatability enhancers are palatability enhancers containing from about 0.01 to about 10 wt. % of one or more amino acids. Examples of amino acids that can be used include, but are not limited to, alanine, glycine, cysteine, and the like. Amino acids that may be present alone or in combination include glycine, L-alanine, and the like. An amino acid level may be between about 0.1 wt. % and about 4.0 wt. %.

Among the same or other palatability enhancers are palatability enhancers containing from about 5 wt. % to about 70 wt. % of one or more microbial or vegetable proteins. Examples of microbial proteins that can be used include, but are not limited to, brewer's yeast, baker's yeast, and the like. Examples of vegetable proteins that can be used include, but are not limited to, corn gluten, soy protein, soy flour, hydrolyzed vegetable protein (HVP), and the like. Microbial or vegetable protein levels may be from about 10 wt. % to about 40 wt. %. Among the same or other palatability enhancers are palatability enhancers containing from about 0.01 wt. % to about 50 wt. % of one or more carbohydrates. Examples of carbohydrates that can be used include, but are not limited to, glucose, xylose, fructose, starch hydrolysates, and the like. A carbohydrate level may be between about 10 wt. % and about 30 wt. %.

One example of a formulation has a solids content of from about 10 wt. % to about 40 wt. % of one or more palatability enhancing compounds; about 30 wt. % to about 60 wt. % of one or more products or byproducts selected from animal products, animal byproducts, fish products, fish byproducts, dairy products, and dairy byproducts; from about 25 wt. % to about 35 wt. % of one or more sources of microbial proteins; from about 1 wt. % to about 9 wt. % by weight bisulfite; from about 0.1 wt. % to about 1.0 wt. % of one or more antioxidants; from about 2 wt. % to about 4 wt. % of one or more amino acids; and from about 0.5 wt. % to about 60 wt % of one or more carbohydrates.

Dry formulations have a solids content of about 96 wt. %. Liquid formulations may be diluted to a total solids content as low as about 30 wt. % with water and to a solids content no more than about 50 wt. % to obtain a viscosity and rheology suitable for spray application.

The water content may also be supplied by moisture-containing or liquid components such as aqueous bisulfite solutions, the amounts of which are selected by well-known techniques to maintain the solids content of the product. Liquid formulations according to the present disclosure have a pH between about 2 and about 9. Liquid formulations may have a pH between about 2 and about 3.

To make a liquid palatability enhancer formulation, for example, commercially available liquid ingredients are combined in a mixer. Wet ingredients are ground or emulsified to a slurry and the liquid ingredients are combined therewith. A commercially available protease may be added to the slurry to hydrolyze proteins, and later inactivated with heat, acid or another method. Preservatives such as sorbic acid can also be added. Water is added to adjust the viscosity and the solids content of the slurry to facilitate spray application. The wet palatability enhancer is sprayed onto the product so as to achieve a uniform coating and permitted to dry.

A dry formulation of the palatability enhancer may be prepared by combining commercially available dry ingredients, including the palatability enhancing compound, dry metabisulfite, amino acids, inorganic salts and organic materials in the desired proportions in a batch mixer and blending to homogeneity prior to drying.

The following non-limiting examples set forth below illustrate certain aspects of the disclosure. These examples are not intended to limit the scope, but rather to exemplify preferred embodiments. All parts and percentages are by weight unless otherwise noted.

### EXAMPLES

### Example 1

Fresh rice bran equal to 100 pounds was suspended in about 500 pounds water of elevated temperature (e.g., 140° F.), at a ratio of 1:5 bran (wt.)/water (wt.). A pH of approximately 10 was achieved by adding an amount of food-grade sodium hydroxide. The pH was measured using a pH meter manufactured by Fisher Scientific. After a 30-minute period, food grade acid hydrochloric acid was added to reduce the pH to about 7.0. The below table shows the amount of fatty acids found in treated and untreated bran.

TABLE 1

| | | | Control Bran Treated | |
|---|---|---|---|---|
| Time | Control | Base Treated Bran | with Base at 72 Hours | |
| 0 hr | 0.55 | 0.46 | 0.61 | |
| 12 hr | 9.77 | 0.51 | 10.3 | |
| 24 hr | 14.4 | 0.44 | 15.1 | |
| 72 hr | 29.0 | 0.6 | 28.8 | 0.50* |
| 96 hr | 44.5 | 0.53 | | 0.55** |

How measured:
Free fatty acids in milliequivalents (meq) present in control bran and base treated bran.
*Values of control bran before and after treatment with base
**Value of treated control bran at 96 hours post milling and 24 hours after treatment with base

The fatty acids were determined using the Association of Analytical Communities (AOAC) procedure 940.28.

The treatment stabilized the rice bran by eliminating the substrate for lipase, and by converting all fatty acids, free or in glycerol acyl esters, to salts of fatty acids, thus eliminating the potential for rancidity. As can be seen from the above table, the present method maintains the level of free fatty acids. When the control product was treated, which had increased levels of free fatty acids, the fatty acids were decreased to levels similar to those in products treated initially.

### Example 2

Rice bran, whether old or fresh, was loaded into the throat of a short soybean Anderson expander (3 foot minimum) at a rate of about 80 to about 95 pounds per hour along with food-grade aqueous sodium hydroxide or potassium hydroxide at a rate of about 5 to about 20 pounds per hour, and aqueous bisulfite or metabisulfite solution. The expander (or alternatively, extruder or expeller) could be any size. The advantage to an expander compared to an extruder or expeller is that the product is fluffy and ready for oil extraction or can be used as is.

The expander received pressurized steam to its outer jacket. The untreated rice bran mixture resided in the screw for at least about 30 seconds at a temperature of about 315° F. to about 325° F. Lower temperatures had longer residence times and an increased risk of not inactivating native lipases in the rice bran.

Fatty acid concentrations were determined by hydroxide titration before saponification. The breakdown of fats in the rice bran varies greatly as time from milling increases, requiring different amounts of hydroxide to be used. Thus, the amount of hydroxide necessary for saponification was determined based on the particular titration results.

The bisulfite solution was added to the untreated bran until the mixture had a concentration of about 200 ppm to about 350 ppm bisulfites. The bisulfite solution may be added simultaneously or separately from the food-grade hydroxide. While saponification occurred almost immediately upon contact with the untreated bran, the bisulfite solution remained with the bran after expulsion to react with aldehydes and ketones. These aldehydes and ketones formed from extended oxidation of unsaturated long chain fats and later scission to aldehydes and ketones, as described in Morrison & Boyd, Organic Chemistry, third edition.

Optionally, the treated rice bran was contacted with a food-grade acid to obtain a pH of about 6.5 to about 7.5. Neutralization may occur simultaneously with bisulfite addition but must occur after the saponification reaction is complete.

Total throughput was about 1300 pounds per hour. The system ran as a continuous process (see FIG. 1), but may also be run as a batch process in a tank using an adequate amount of water (see FIG. 2).

After expansion, the treated bran was dried in an open-holed rotary dryer or a similar device. Dried tried bran was sent to a 20 kg or 50# bagger. Optionally, after processing, the bran product was packaged in 1- to 2-pound amounts. Residual bisulfites controlled mold growth up to at least a 20 wt. % moisture and continued to eliminate aldehydes and ketones as they form during the shelf life of the treated bran.

### Example 3

Fresh rice bran was treated with sodium metabisulfite at the expander throat and heat processed by expansion. Between 5 ppm (0.0005 wt. %) and 1000 ppm (0.10 wt. %) metabisulfite were tested and compared to a control, which was only treated with the volume of water used to carry the metabisulfite in the test samples. After treatment, the bran was stored at 120° F. and 90% humidity to accelerate aging, thereby modeling one month of room temperature storage per week under accelerated storage conditions. The study was conducted over 20 weeks, which approximated 20 months of storage under ambient conditions. Weekly samples were removed and analyzed by gas chromatography (Agilent 5890 GC) for n-hexanal concentrations.

The production of n-hexanal from unsaturated lipids over time is known in the art and can be used to measure autooxidation of unsaturated lipids. The correlation between n-hexanal and peroxide values is strong (as high as R²=0.99) and has been demonstrated to be highly sensitive to measuring lipid degradation, as n-hexanal is the predominant aldehyde produced by lipid autooxidation. Furthermore, n-hexanal above 1.00 millieq/kg were offensive in odor and taste.

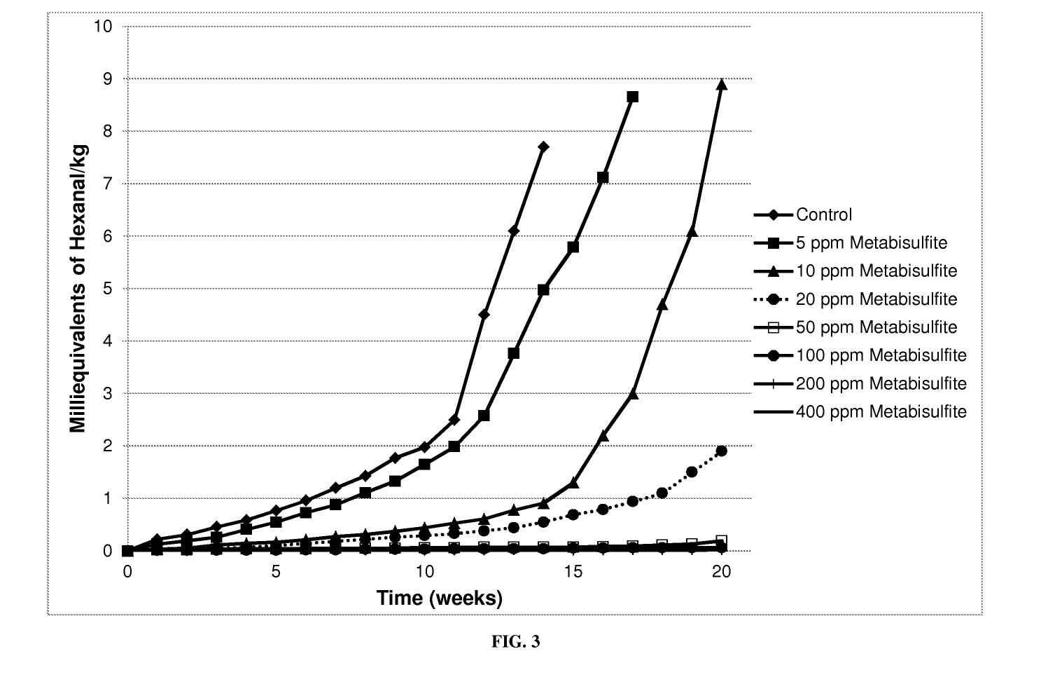

It was observed that the higher level of metabisulfite added to the bran reduced the production of n-hexanal and other aldehydes and ketones, whereas the lower concentrations of metabisulfite (≧10 ppm) did not effectively extend shelf life. It was determined 200 ppm (0.02 wt. %) metabisulfite provided the greatest shelf life under the experimental conditions (simulated 20 month; see FIG. 3). Additional metabisulfite beyond 200 ppm provided no additional benefit for shelf life, odor, or taste under the conditions tested.

In conclusion, adding at least 200 ppm metabisulfite to fresh bran at the expander/extruder/expeller throat substantially eliminated the production of volatile aldehydes and ketones through their immediate conversion to non-volatile compound without odor or taste, thus extending shelf life of fresh bran for at least about two years. Combined with the use of OH— to eliminate short chain fatty acids that result from the nascent rice bran lipase, the product has improved shelf life and added value through its ability to be stored and shipped internationally Without wishing to be bound by theory, stale flavors in stored rice or rice bran come from the attack of linolenic acid by oxygen with the eventual formation of aldehydes and ketones. Using the methods disclosed herein, rice and rice bran can be protected from going stale without relying upon cold storage or the total removal of oxygen. These methods can be applied to other sources of bran.

Having described several embodiments, it will be recognized by those skilled in the art that various modifications, alternative constructions, and equivalents may be used without departing from the spirit of the disclosure. Additionally, a number of well-known processes and elements have not been described in order to avoid unnecessarily obscuring the embodiments disclosed herein. Accordingly, the above description should not be taken as limiting the scope of the document.

Those skilled in the art will appreciate that the presently disclosed embodiments teach by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A method for treating untreated rice bran to produce a treated rice bran, comprising:
a. inactivating lipase in the untreated rice bran;
b. saponifying fatty acids in the untreated rice bran to fatty acid salts; and
c. contacting the untreated rice bran with a source of bisulfite anions so that an aldehyde or ketone in the untreated rice bran forms an organosulfite;
whereby the treated rice bran is produced, wherein the amount and characterization of protein and fiber between the treated rice bran and the untreated rice bran remain unchanged.

2. The method of claim 1, wherein the inactivating step is selected from thermal inactivation and enzymatic inactivation.

3. The method of claim 2, further comprising adding water to the untreated rice bran to form untreated hydrated rice bran.

4. The method of claim 3, wherein the inactivating step comprises heating the untreated hydrated rice bran to a temperature of between about 40° F. and about 360° F.

5. The method of claim 4, wherein the temperature is between about 120° F. and about 140° F.

6. The method of claim 4, wherein the untreated hydrated rice bran has bran-to-water ratio of about 1:1 to about 1:10 by weight.

7. The method of claim 6, wherein the untreated hydrated rice bran has bran-to-water ratio of about 1:5 by weight.

8. The method of claim 2, wherein the inactivating step is enzymatic inactivation and comprises contacting the untreated rice bran with a protease.

9. The method of claim 8, wherein the protease is an endoprotease, an exoprotease, a non-specific protease, or combinations thereof.

10. The method of claim 8, wherein the protease comprises Genencor® Protex™ 6L.

11. The method of claim 1, wherein the saponifying step comprises adding a food-grade hydroxide to the untreated hydrated rice bran in an amount sufficient to have a pH ranging between about 7.5 and about 14.0, with the food-grade hydroxide contacting the untreated rice bran for between about 0.1 minutes and about 90 minutes.

12. The method of claim 11, wherein the saponifying step comprises adding a food-grade hydroxide to the untreated hydrated rice bran in an amount sufficient to have a pH ranging between about 8.5 and about 11.0, with the food-grade hydroxide contacting the untreated rice bran for between about 15 minutes and about 45 minutes.

13. The method of claim 12, wherein the food-grade hydroxide is added to the untreated rice bran until the bran-hydroxide mixture has a pH of about 10.0 for about 30 minutes.

14. The method of claim 11, wherein the food-grade hydroxide is potassium hydroxide, sodium hydroxide, or combinations thereof.

15. The method of claim 1, wherein the fatty acids saponified are free fatty acids.

16. The method of claim 1, wherein the untreated rice bran is selected from the group consisting of rancid bran, fresh bran, and combinations thereof.

17. The method of claim 1, further comprising, after the saponifying step and commensurate with the bisulfite step, adding a food-grade acid to the untreated rice bran in an amount sufficient to have a pH of between about 5.0 and about 8.0.

18. The method of claim 17, wherein the food-grade acid is added to the bran-hydroxide mixture until the pH reaches about 6.5.

19. The method of claim 17, wherein the food-grade acid is hydrochloric acid, phosphoric acid, acetic acid, or combinations thereof.

20. The method of claim 1, wherein the source of bisulfite anions is an alkali metabisulfite, an aqueous solution of hydrated bisulfite, or combinations thereof.

21. The method of claim 20, wherein the aqueous solution of hydrated bisulfite is an aqueous solution of ammonium metabisulfite, alkali bisulfite, or combinations thereof.

22. The method of claim 21, wherein the alkali bisulfite is sodium bisulfite, potassium bisulfite, or combinations thereof.

23. The method of claim 22, wherein the bisulfite anion concentration in the aqueous solution is between about 0.0001% and about 20% by dry weight of the untreated rice bran.

24. The method of claim 23, wherein the bisulfite anion concentration in the aqueous solution is about 1% and about 9% by dry weight of the untreated rice bran.

25. The method of claim 1, further comprising drying the treated rice bran.

26. The method of claim 25, wherein the treated rice bran has a water content of 6% to 20% by weight after the drying step.

27. A method for treating untreated hydrated rice bran to produce a treated hydrated rice bran, comprising:
a. adding a food-grade hydroxide to the untreated hydrated rice bran in an amount sufficient to have a pH of between about 7.5 and about 14.0 and to saponify the fatty acids to fatty acid salts; and
b. contacting the untreated hydrated rice bran with a source of bisulfite anions to form a organosulfite from an aldehyde or ketone within the untreated hydrated rice bran.

28. The method of claim 27, further comprising adding, after the saponifying step and commensurate with the bisulfite step, a food-grade acid to the untreated hydrated rice bran containing the fatty acid salts to thereby lower the pH to between about 5.0 and about 8.0.

29. A method for converting rancid rice bran to palatable rice bran, comprising:
a. adding a food-grade hydroxide to the rancid rice bran in an amount sufficient to have a pH of between about 7.5 and about 14.0 and to saponify the fatty acids to fatty acid salts; and
b. contacting the rancid rice bran with a source of bisulfite anions to form a organosulfite from an aldehyde or a ketone within the rancid rice bran.

30. A method for stabilizing rice bran, comprising:
a. heating the rice bran to between about 40° F. and about 360° F.;
b. adding a food-grade hydroxide to the rice bran in an amount sufficient to have a pH ranging between about 7.5 and about 14.0, with the hydroxide contacting the rice bran for between about 0.1 minutes and about 90 minutes, whereby fatty acids within the rice bran are saponified to fatty acid salts;
c. adding a food-grade acid to the rice bran in an amount sufficient to have a pH of between about 5.0 and about 8.0;
d. contacting the rice bran with a source of bisulfite anions so that an aldehyde or a ketone forms an organosulfite; and
e. separating the remaining water from the rice bran by drying the rice bran.

31. The method of claim 30, wherein the rice bran is heated to a temperature of about 120° F. to about 140° F. at a pH of about 8.5 to about 11.0.

32. A treated rice bran composition, comprising:
fatty acid salts;
inactivated lipase;
organosulfites;
between about 14% and about 16% by weight protein; and
between about 8% and about 10% by weight fiber.

33. The treated rice bran composition of claim 32, having a pH between 5.0 and 8.0.

34. The treated rice bran composition of claim 32, having water content of between 6% by weight to 20% by weight.

35. A rice bran admixture, comprising:
rice bran;
water in a bran-to-water ratio of about 1:1 to about 1:10 by weight;
an amount of food-grade hydroxide sufficient for the rice bran admixture have a pH of between about 7.5 and about 14.0; and
between about 0.0001% and about 1.25% by weight of bisulfite.

36. The rice bran admixture of claim 35, wherein the rice bran had been treated with a protease before entering the admixture.

37. A method for treating untreated rice bran to produce a treated rice bran, comprising:
a. feeding the untreated rice bran into a cooker;
b. applying within the cooker a temperature of between about 40° F. and about 360° F.;
c. adding a food-grade hydroxide to the cooker in an amount sufficient to have a pH ranging between about 7.5 and about 14.0, with the food-grade hydroxide contacting the untreated rice bran for between about 0.1 minutes and about 90 minutes, whereby the fatty acids in the untreated rice bran are saponified to fatty acid salts; and
d. contacting within the cooker the untreated rice bran with a source of bisulfite anions so that an aldehyde or ketone in the untreated rice bran forms an organosulfite;
whereby the treated rice bran is produced, wherein the amount and characterization of protein and fiber between the treated rice bran and the untreated rice bran remain unchanged.

38. The method of claim 37, wherein the method is a continuous process.

39. The method of claim 37, wherein the cooker is selected from one or more in the group consisting of expander, extruder, expeller, and combinations thereof.

40. The method of claim 39, wherein the cooker is an expander.

41. The method of claim 37, wherein the temperature is between about 120° F. and about 140° F.

42. The method of claim 37, wherein the food-grade hydroxide is added to the untreated rice bran until the bran-hydroxide mixture has a pH from between about 8.5 and about 11.0 for between about 15 minutes and about 45 minutes.

43. The method of claim 42, wherein the food-grade hydroxide is added to the untreated rice bran until the bran-hydroxide mixture has a pH of about 10.0 for about 30 minutes.

44. The method of claim 37, wherein the food-grade hydroxide is potassium hydroxide, sodium hydroxide, or combinations thereof.

45. The method of claim 37, wherein the fatty acids saponified are free fatty acids.

46. The method of claim 37, wherein the untreated rice bran is selected from the group consisting of rancid bran, fresh bran, and combinations thereof.

47. The method of claim 37, further comprising, after the saponifying step and commensurate with the bisulfite step, adding a food-grade acid to the untreated rice bran in an amount sufficient to have a pH of between about 5.0 and about 8.0.

48. The method of claim 47, wherein the food-grade acid is added to the bran-hydroxide mixture until the pH reaches about 6.5.

49. The method of claim 47, wherein the food-grade acid is hydrochloric acid, phosphoric acid, acetic acid, or combinations thereof.

50. The method of claim 37, wherein the source of bisulfite anions is an alkali metabisulfite, an aqueous solution of hydrated bisulfite, or combinations thereof.

51. The method of claim 50, wherein the aqueous solution of hydrated bisulfite is an aqueous solution of ammonium metabisulfite, alkali bisulfite, or combinations thereof.

52. The method of claim 51, wherein the alkali bisulfite is sodium bisulfite, potassium bisulfite, or combinations thereof.

53. The method of claim 52, wherein the bisulfite anion concentration in the aqueous solution is between about 0.0001% and about 20% by dry weight of the untreated rice bran.

54. The method of claim 53, wherein the bisulfite anion concentration in the aqueous solution is about 1% and about 9% by dry weight of the untreated rice bran.

55. The method of claim 37, further comprising drying the treated rice bran.

56. The method of claim 55, wherein the treated rice bran has a water content of 6% to 20% by weight after the drying step.

57. The method of claim 37, wherein the treated rice bran exits the cooker at a temperature ranging between about 265° F. and about 380° F.

58. The method of claim 57, wherein the temperature ranges between about 300° F. and about 350° F.

59. The method of claim 58, wherein the temperature is about 325° F.
